(19) United States
(12) Patent Application Publication
(10) Pub. No.: US 2012/0043357 A1
(43) Pub. Date: Feb. 23, 2012

(54) DEVICE AND METHOD FOR CARRYING A TURKEY

(76) Inventor: John L. CAMPBELL, Everett, WA (US)

(21) Appl. No.: 12/860,101

(22) Filed: Aug. 20, 2010

(51) Int. Cl. A01M 31/00; F41C 33/00

(52) U.S. Cl. 224/103; 224/269; 224/150; 224/575

(57) ABSTRACT

An apparatus and method for carrying a turkey. An embodiment may include an elongated body member that is attached to a clip that may engage a belt. Further, the body member may include a shoulder support as well as a plurality of turkey-leg-engagement loops suited to engage and support a pair of turkey legs. In this manner, the turkey carrier may provide the securing force with the engagement loops that were once provided by the person's clenched fists. Further, the gravitational force of the weight of the turkey is dispersed over wider shoulder support area and is fully transferred to the belt clip coupled to the person's belt

### BACKGROUND

Many people enjoy the sport of hunting with bow and arrow or with rifles and often look to acquire trophy game for show and accolade. Often, hunters must track wildlife into remote areas of wilderness in order to reach state-certified hunting areas or to track the most desired large wildlife suitable for trophy taxidermy and the like. With such hikes into remote areas, retrieving the wildlife becomes a more difficult endeavor. This is especially so since a hunter typically desires to keep the wildlife is presentable condition if the hunter wishes to turn the kill into a trophy later. Thus, transporting the heavy wildlife out of remote wilderness areas without damaging the carcass proves to be a difficult task.

One particularly difficult wildlife to transport is a turkey. Typically a turkey trophy will display the entire bird including its full tail plume so it becomes doubly important to keep the carcass from being drug across the ground or to continuously bump against one's legs or other hunting equipment when trying to carry the game. Furthermore, because the game will likely be presented as the full body (as opposed to just a head when a trophy is made of other wildlife such as an elk or moose), one common way to carry the bird is by the legs so as to not damage the feathers or body. As amateur and connoisseur turkey hunters alike can attest, the most often-employed technique for carrying a turkey carcass is to grab the legs with one of both hands in clenched fists and then sling the bird over one's shoulder. In this manner, the body of the bird hangs down the backside of the carrier while his or her hands clench the legs to keep the bird's legs supported over the shoulder. Needless to say, over a lengthy wilderness hike, one's clenched fists become tired and the narrow profile of the turkey's legs tend to apply acute pressure to one's shoulder. To date, these problems have yet to be addressed in the art.

### BRIEF DESCRIPTION OF THE DRAWINGS

Embodiments of the subject matter disclosed herein will become more readily appreciated as the same become better understood by reference to the following detailed description, when taken in conjunction with the accompanying drawings.

FIG. 1 is a diagram of a turkey carrier according to an embodiment of the subject matter disclosed herein.

FIG. 2 is a front view of a person who has the turkey carrier of FIG. 1 engaged according to an embodiment of the subject matter disclosed herein.

### DETAILED DESCRIPTION

The following discussion is presented to enable a person skilled in the art to make and use the subject matter disclosed herein. The general principles described herein may be applied to embodiments and applications other than those detailed above without departing from the spirit and scope of the present detailed description. The present disclosure is not intended to be limited to the embodiments shown, but is to be accorded the widest scope consistent with the principles and features disclosed or suggested herein.

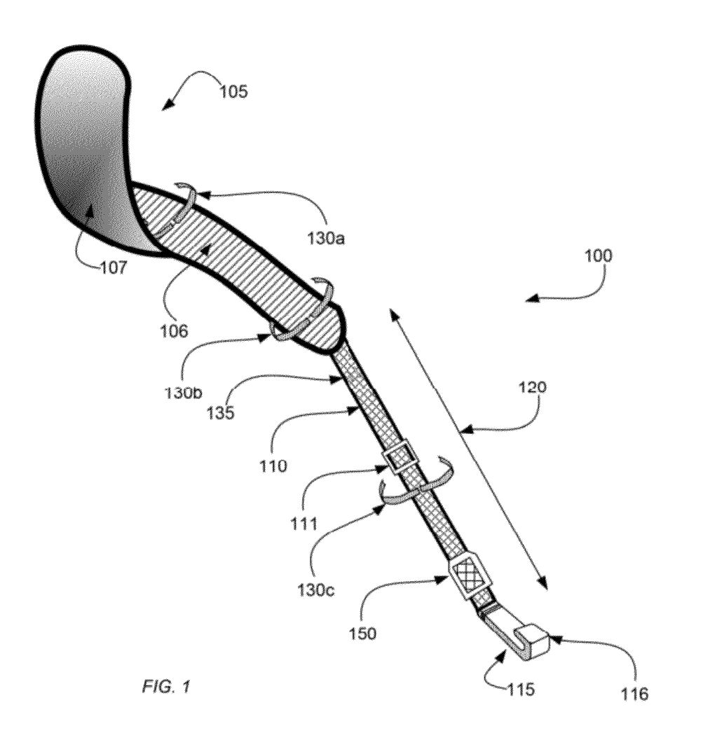

As discussed briefly above, carrying a turkey carcass can be a difficult endeavor when one considers the length of time that one must maintain clenched fists with a load supported by one's shoulder. With a turkey carrier formed in accordance with various embodiments of the subject matter disclosed herein, the weight of the turkey is transferred to a belt clip and the brunt of the shoulder support weight is dispersed over a wider area because of a shoulder support pad. Thus, according to an embodiment, a turkey carrier includes an elongated body member that is attached to a clip that may engage a belt. Further, the body member may include a shoulder support as well as a plurality of turkey-leg-engagement loops suited to engage and support a pair of turkey legs. In this manner, the turkey carrier may provide the securing force with the engagement loops that were once provided by the person's clenched fists. Further, the gravitational force of the weight of the turkey is dispersed over wider shoulder support area and is fully transferred to the belt clip coupled to the person's belt. These and other aspects are discussed in greater detail below with respect to FIGS. 1-3.

FIG. 1 is an isometric view of a turkey carrier 100 according to an embodiment of the subject matter disclosed herein. The turkey carrier 100 includes three main components: an elongated strap or main body member 110 that may include a shoulder support 105, an attachment device 115 (shown as an engagement clip in this embodiment) suited to engage an article of clothing such as a belt and a plurality of engagement mechanisms 130a-c disposed on the elongated strap 110. Together, these components as shown assembled in the apparatus of FIG. 1 provide a means for carrying a turkey in a more effective manner than conventional devices and methods. Several embodiments and advantages are discussed in the next paragraphs.

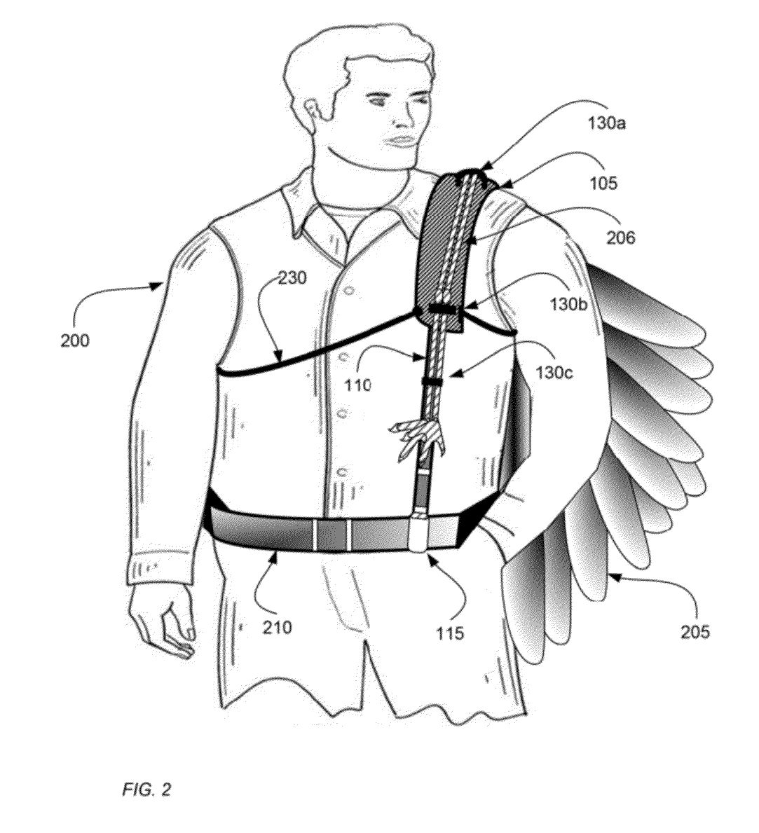

In the embodiment shown in FIG. 1, the engagement mechanisms 130a-c are shown as engagement straps that comprise a pair of elongated strips of material operable to engage each other with a hook and latch system. Thus, as one or both turkey legs (not shown in FIG. 1) of a turkey to be carried are laid upon the elongated strap 110, the engagement straps 130a-c may be looped around the turkey legs so as to hold them in place tightly against the elongated strap. Thus, when the turkey is lifted, the legs are prevented from maneuvering away from the engagement mechanisms. This is shown in greater detail below with respect to FIG. 2.

The engagement mechanisms 130a-c may also be devices other that hook and latch straps. In other embodiments, the engagement mechanisms 130a-c may be punch-hole buckle devices, cinching devices for tightening a rope around the legs, zip ties, or other suitable device for securing turkey legs to the elongated strap 110. Further, the elongated strap 110 may include additional points beyond. the three engagement mechanisms 130a-c shown, such as eyeholes 135 for a separate zip tie to be used to more securely hold the turkey legs in place.

The turkey carrier of FIG. 1, may further include a shoulder pad 105 attached to an end of the elongated strap 110. Specifically, the shoulder pad 105 is intended to provide a means for distributing the gravitational force of the weight of a carried turkey about a larger surface area. In this manner, a person carrying the turkey with the apparatus of FIG. 1 will not having a narrow portion of the elongated strap 110 digging into the person's shoulder. This is illustrated more clearly in FIG. 2 as described below. The shoulder pad 105 may further include a first side 107 comprising a neoprene rubber material and a second side 106 comprising a canvas material. The neoprene rubber side 107, or other suitable material, provides enough friction so as to prevent this portion of the apparatus 100 from sliding around on one's shoulder when the apparatus 100 is engaged with a carried turkey. The canvas side 106, or other suitable material, provides a robust surface that is resistant to wear-and-tear from the engaged turkey legs. Finally, the elongated strap 110 may also be made from burlap, leather, canvas, woven rope, woven linen or any other suitable material to provide the necessary robust and lightweight features. Further, the elongated strap may also include an elastic member coupled between the strap and the anchor device to provide a bit of play as the turkey may be jostled around when the person is walking.

The elongated strap 110 may also include an adjustable portion suited to be adjusted to the size of a human torso. Thus, a looping adjustment point 111 may be adjusted depending on the size of a person using the apparatus 100 to carry a turkey. Further, the shoulder pad may also be adjustable from the other end of the elongated strap 110. Typically, when a person engages the apparatus to carry a turkey, one may first fasten the engagement device with one's belt, and then adjust the elongated strap 110 until the shoulder pad 105 is positioned on the person's shoulder and the turkey is hanging in a comfortable manner from behind. Other devices for providing adjustments to the overall length of the elongated strap 110 are contemplated but not discussed herein for brevity.

Additionally, the elongated strap 110 may also include a quick-release device 150 that allows a person to depress a button or sides of a clasp to release the majority of the apparatus 100 from the engagement device 115. In this manner, the apparatus 100 as well as an engaged turkey may be quickly disengaged from the anchor point at the engagement clip 115. Such a device 150 may even be configured to release if a force beyond a certain threshold acts upon the apparatus 100. Thus, if the apparatus becomes caught in machinery or around rocks or trees during a fall, the device releases before the person, who otherwise could not get free of the engagement clip 115 securely fastened to his or her belt, is cleared from this danger.

The entire apparatus 100, as mentioned previously, may engage with a person's equipment or clothing such that the person may have both hands free and still securely carry a turkey. The engagement device 115 may be a clip that includes a U-shaped section 116 that is suited to fit around a belt (not shown in FIG. 1). The clip 115 of the embodiment of FIG. 1 may be made of aluminum, extruded plastic, steel, and alloys thereof. In other embodiments not shown the engagement device 115 may be more intricate and involve a looping mechanism to be secured all the way around one's belt or may even be an entire utility vest suited to engage a quick-release device 150 as discussed above. These features and advantages are further described with respect to FIG. 2.

FIG. 2 is a front view of a person who has the turkey carrier 100 of FIG. 1 engaged according to an embodiment of the subject matter disclosed herein. As can be seen, the turkey carrier 100 is engaged with the person and the carried turkey is shown hanging behind the person such that both hands are free. The turkey carrier 100, as before, includes a strap 110 having a first end near the person's belt 210, and a second end draped over the person's shoulder. The turkey carrier includes an engagement device or an anchor device 115 attached to the first end of the strap 110 and engaged at an anchor point on the person's belt 210. Additionally, a plurality of engagement mechanisms 130a-c are disposed on the strap 110 and suited to engage an object, such as a turkey 205 at its turkey legs 206. In essence, the apparatus 100 is suited to carry any object having a narrow portion and a bulky portion, the narrow portion being engaged at the engagement mechanisms 130a-c such that the bulky portion is suspended from the second end of the strap 110 behind the person.

The turkey carrier 100 may also include additional lateral straps 230 suited to engage a human chest when the turkey carrier is engaged with the human such the body member is impeded from moving laterally. Further, as shown in FIG. 2, the shoulder pad 105 includes a surface on its bottom side facing the person's shoulder for preventing the strap from laterally moving when draped over the shoulder.

While the subject matter discussed herein is susceptible to various modifications and alternative constructions, certain illustrated embodiments thereof are shown in the drawings and have been described above in detail. It should be understood, however, that there is no intention to limit the claims to the specific forms disclosed, but on the contrary, the intention is to cover all modifications, alternative constructions, and equivalents falling within the spirit and scope of the claims.

What is claimed is:

1. A turkey carrier, comprising:
an elongated body member having a first end and a second end;
a clip attached to the body member at the first end and operable to engage a belt; and
a plurality of engagement straps suited to engage one or more turkey legs.

2. The turkey carrier of claim 1 wherein the engagement straps comprise a pair of elongated strips of material operable to engage each other with a hook and latch system.

3. The turkey carrier of claim 1, further comprising a shoulder pad attached to the second end of the body member.

4. The turkey carrier of claim 3 wherein the shoulder pad comprises a first side comprising a neoprene rubber material and a second side comprising a canvas material.

5. The turkey carrier of claim 1 wherein the elongated body member comprises an adjustable portion suited to be adjusted to the size of a human torso.

6. The turkey carrier of claim 1 wherein the clip comprises one of the group including: aluminum, extruded plastic, steel, and alloys thereof.

7. The turkey carrier of claim 1 wherein the attachment point between the body member and the clip comprises a quick-release attachment suited to disengage when a force acting on the attachment point exceeds a threshold.

9. The turkey carrier of claim 1 wherein body member comprises a material from the group including: burlap, leather, canvas, woven rope, and woven linen.

10. The turkey carrier of claim 1, further comprising a lateral strap suited to engage a human chest when the turkey carrier is engaged with the human such the body member is impeded from moving laterally.

11. The turkey carrier of claim 1, further comprising eyeholes in the body member suited to allow a zip tie to engage a turkey leg to secure the turkey leg to the body member.

12. An apparatus for carrying an object, comprising:
a strap having a first end and a second end, the strap suited to be draped over a shoulder of a human;
an anchor device attached to the first end of the strap and operable to engage an anchor point on the human; and
a plurality of engagement mechanisms disposed on the strap and suited to engage an object having a narrow portion and a bulky portion, the narrow portion being engaged at the engagement mechanisms such that the bulky portion is suspended from the second end of the strap.

13. The apparatus of claim 12 wherein the object comprises a turkey.

14. The apparatus of claim 12 wherein the anchor point comprises a belt.

15. The apparatus of claim 12, further comprising a shoulder pad attached to the strap near the second end and suited to provide a surface for preventing the strap from laterally moving when draped over the shoulder.

16. The apparatus of claim 12 wherein the engagement mechanisms comprise one from the group including: hook and latch strap, zip tie, strap and buckle, and cinching strap.

17. The apparatus of claim 12, further comprising three engagement mechanisms.

18. The apparatus of claim 12, further comprising an elastic member coupled between the strap and the anchor device.

19. A gun sling, comprising:
an elongated body member having a first end and a second end;
a first attachment device attached to the body member at the first end and operable to engage a first end of a gun and a second attachment device attached to the body member at the second end and operable to engage a section of the gun other than the first end; and
a plurality of engagement straps disposed on the body member and suited to engage one or more turkey legs.
